(19) United States
(12) Patent Application Publication
(10) Pub. No.: US 2026/0155671 A1
(43) Pub. Date: Jun. 4, 2026

(54) TECHNIQUES FOR TIME SHIFTING DISCHARGING AND CHARGING OF A UPS BATTERY

(71) Applicant: SCHNEIDER ELECTRIC IT CORPORATION, Foxboro, MA (US)

(72) Inventors: Flemming Johansen, Kolding (DK); Andres Papso Laursen, Taulov (DK)

(21) Appl. No.: 18/965,370

(22) Filed: Dec. 2, 2024

(51) Int. Cl. H02J 7/00; H02J 3/28; H02J 9/06

(52) U.S. Cl. CPC H02J 7/971; H02J 3/28; H02J 7/825; H02J 7/92; H02J 7/933; H02J 9/062

(57) ABSTRACT

Techniques are provided for managing discharging and recharging a battery. The techniques include (a) receiving, from a utility server, pricing information for provision of power by a utility over a lookahead period; (b) determining, with reference to the pricing information, a highest cost of the power over a subset of the lookahead period and a lowest cost of the power over the subset, the highest cost occurring during a first time slot of the subset; (c) in response to determining that a discharge condition is satisfied, assigning the first time slot as a discharge time slot, including: (1) determining that a battery of a power supply device has a state of charge (SoC) of at least a fullness threshold and (2) determining that a difference between the highest cost and the lowest cost exceeds a threshold value; and (d) during the discharge time slot, operating the power supply device to provide power to connected devices using power drawn from the battery.

### BACKGROUND

Uninterruptible Power Supply (UPS) units provide a backup source of power to electrical equipment in the event of a power failure. UPS units typically utilize one or more batteries to provide the backup power. Although various types of batteries may be used, in recent years, use of lithium-ion (Li-Ion) batteries has become more popular due to their high energy density and long lifespan.

### SUMMARY

A computer program product is provided according to some embodiments. The computer program product includes a non-transitory computer-readable storage medium storing instructions, which, when executed by processing circuitry of a charging apparatus, cause the charging apparatus to (a) receive, from a utility server, pricing information for provision of power by a utility over a lookahead period; (b) determine, with reference to the pricing information, a highest cost of the provision of power over a subset of the lookahead period and a lowest cost of the provision of power over the subset of the lookahead period, the highest cost occurring during a first time slot of the subset of the lookahead period; (c) in response to determining that a discharge condition is satisfied, assign the first time slot as a discharge time slot, wherein determining that the discharge condition is satisfied includes: (1) determining that a battery of a power supply device has a state of charge (SoC) of at least a fullness threshold and (2) determining that a difference between the highest cost and the lowest cost exceeds a threshold value; and (d) during the discharge time slot, operate the power supply device to provide power to connected devices using power drawn from the battery.

In some embodiments, the instructions, when performed by the processing circuitry, further cause the system to, in response to determining that the battery of the power supply device is in a partially discharged state after the discharge time slot: (e) determine a new lowest cost of the provision of power over another subset of the lookahead period, the other subset being completely after the discharge time slot, the new lowest cost occurring during a second time slot of the other subset of the lookahead period; (f) assign the second time slot as a recharge time slot; and (g) during the recharge time slot, operate the power supply device to recharge the battery from the utility.

In some of these embodiments, the subset and the other subset are non-overlapping, the other subset beginning immediately after the subset.

In some of these embodiments, the lookahead period is at least 24 hours; the subset includes 12 non-overlapping time slots that are each 1 hour long, including the first time slot; and the other subset includes 12 non-overlapping time slots that are each 1 hour long, including the second time slot.

In some embodiments, determining that the discharge condition is satisfied further includes determining that a number of discharges over a lookback period does not exceed a maximum allowed number of discharges.

In some of these embodiments, the threshold value is a sliding threshold based on the number of discharges over the lookback period. In one of these embodiments, the sliding threshold is defined by multiplying an acceptable price difference by the number of discharges over the lookback period divided by the maximum allowed number of discharges.

In some of these embodiments, the lookback period is within a range of 10 to 50 (e.g., 30) days.

In some of these embodiments, the maximum allowed number of discharges is within a range of 5 to 10 (e.g., 8 times).

In some embodiments, providing power to connected devices using power drawn from the battery includes drawing power from the battery at a discharge rate defined by a present SoC of the battery minus a minimum allowed SoC of the battery divided by a remaining amount of time left in the discharge time slot. In some of these embodiments, the minimum allowed SoC of the battery is within a range of 50% to 80%.

In some embodiments, the fullness threshold is a value within a range of 85% to 100%.

In some embodiments, receiving the pricing information for provision of power from the utility server includes a lookup server device obtaining the pricing information from the utility server and the lookup server device sending the obtained pricing information to the power supply device; and determining the highest cost and lowest cost and assigning the first time slot as the discharge time slot are performed by the power supply device.

In some embodiments, the processing circuitry is within the power supply device.

A system is provided according to some embodiments. The system includes (I) a power supply device and (II) processing circuitry coupled to memory configured to: (a) receive, from a utility server, pricing information for provision of power by a utility over a lookahead period; (b) determine, with reference to the pricing information, a highest cost of the provision of power over a subset of the lookahead period and a lowest cost of the provision of power over the subset of the lookahead period, the highest cost occurring during a first time slot of the subset of the lookahead period; (c) in response to determining that a discharge condition is satisfied, assign the first time slot as a discharge time slot, wherein determining that the discharge condition is satisfied includes: (1) determining that a battery of a power supply device has a state of charge (SoC) of at least a fullness threshold and (2) determining that a difference between the highest cost and the lowest cost exceeds a threshold value; and (d) during the discharge time slot, operate the power supply device to provide power to connected devices using power drawn from the battery.

In some embodiments, the processing circuitry coupled to memory is within the power supply device.

In some embodiments, the system further comprises (III) a lookup server device configured to: obtain the pricing information from the utility server and send the obtained pricing information to the power supply device; and the processing circuitry configured to determine the highest cost and lowest cost and the processing circuitry configured to assign the first time slot as the discharge time slot are within the power supply device.

A method performed by processing circuitry is provided according to some embodiments. The method includes (a) receiving, from a utility server, pricing information for provision of power by a utility over a lookahead period; (b) determining, with reference to the pricing information, a highest cost of the provision of power over a subset of the lookahead period and a lowest cost of the provision of power over the subset of the lookahead period, the highest cost occurring during a first time slot of the subset of the lookahead period; (c) in response to determining that a discharge condition is satisfied, assigning the first time slot as a discharge time slot, wherein determining that the discharge condition is satisfied includes: (1) determining that a battery of a power supply device has a state of charge (SoC) of at least a fullness threshold and (2) determining that a difference between the highest cost and the lowest cost exceeds a threshold value; and (d) during the discharge time slot, operating the power supply device to provide power to connected devices using power drawn from the battery.

In some embodiments, the method further comprises, in response to determining that the battery of the power supply device is in a partially discharged state after the discharge time slot: (e) determining a new lowest cost of the provision of power over another subset of the lookahead period, the other subset being completely after the discharge time slot, the new lowest cost occurring during a second time slot of the other subset of the lookahead period; (f) assigning the second time slot as a recharge time slot; and (g) during the recharge time slot, operating the power supply device to recharge the battery from the utility.

In some of these embodiments, the subset and the other subset are non-overlapping, the other subset beginning immediately after the subset.

In some of these embodiments, the lookahead period is at least 24 hours; the subset includes 12 non-overlapping time slots that are each 1 hour long, including the first time slot; and the other subset includes 12 non-overlapping time slots that are each 1 hour long, including the second time slot.

In some embodiments, determining that the discharge condition is satisfied further includes determining that a number of discharges over a lookback period does not exceed a maximum allowed number of discharges.

In some of these embodiments, the threshold value is a sliding threshold based on the number of discharges over the lookback period. In one of these embodiments, the sliding threshold is defined by multiplying an acceptable price difference by the number of discharges over the lookback period divided by the maximum allowed number of discharges.

In some of these embodiments, the lookback period is within a range of 10 to 50 (e.g., 30) days.

In some of these embodiments, the maximum allowed number of discharges is within a range of 5 to 10 (e.g., 8 times).

In some embodiments, providing power to connected devices using power drawn from the battery includes drawing power from the battery at a discharge rate defined by a present SoC of the battery minus a minimum allowed SoC of the battery divided by a remaining amount of time left in the discharge time slot. In some of these embodiments, the minimum allowed SoC of the battery is within a range of 50% to 80%.

In some embodiments, the fullness threshold is a value within a range of 85% to 100%.

In some embodiments, receiving the pricing information for provision of power from the utility server includes a lookup server device obtaining the pricing information from the utility server and the lookup server device sending the obtained pricing information to the power supply device; and determining the highest cost and lowest cost and assigning the first time slot as the discharge time slot are performed by the power supply device.

In some embodiments, the method is performed by the power supply device.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 illustrates an example system, apparatus, and computer program product for use in connection with one or more embodiments.

FIG. 2 illustrates an example method in accordance with one or more embodiments.

FIGS. 3A and 3B illustrate example usage scenarios in accordance with one or more embodiments.

### DETAILED DESCRIPTION

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

As discussed above, UPS units are configured to provide power to devices in the event of a power failure. The remainder of the time, UPS units typically provide electrical power derived from the power grid to the protected devices.

Unfortunately, the cost of power from the power grid can vary significantly throughout the day, due to fluctuations in supply and demand. Thus, it would be desirable to power the protected devices using battery power during high-cost periods while recharging the battery of the UPS during low-cost periods.

This may be accomplished by configuring a UPS unit to obtain pricing information over a plurality of time slots from the power utility, to power its protected devices using its battery during a time slot when the power cost is high, and to recharge its battery during a time slot when the power cost is low. Since frequent charging of a Li-Ion battery can be detrimental to the long-term health of the battery, in some embodiments, this time shifting of power usage may be limited in frequency (e.g., no more than 8 times per month). In some embodiments, this time shifting of power may be limited to periods when the price differential between a highest cost and a lowest cost exceeds a threshold. In some embodiments, the threshold may be a sliding threshold based on how frequently the time shifting has been employed recently.

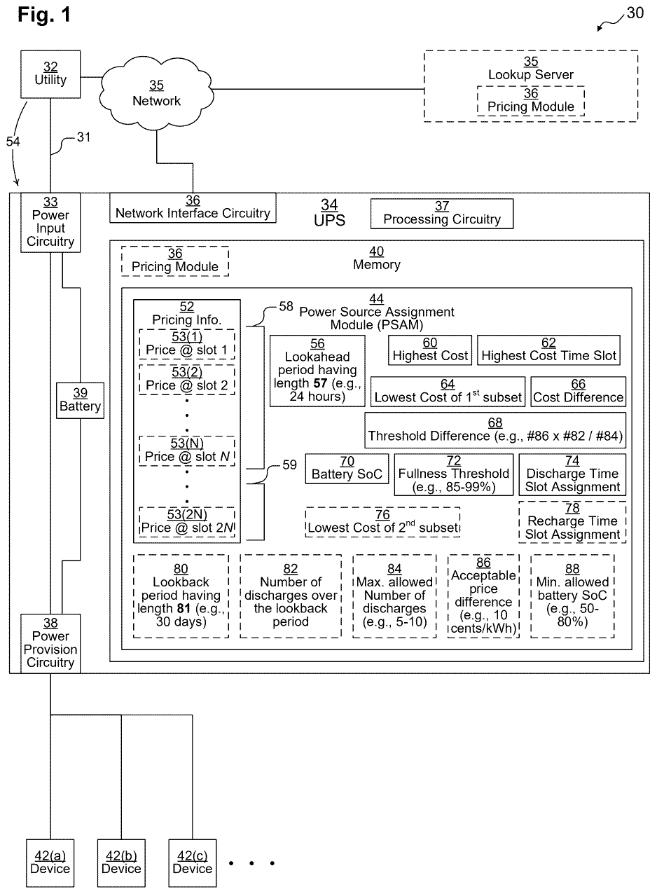

FIG. 1 depicts an example environment 30 for use in connection with various embodiments described herein. Environment 30 includes a power utility 32 that provides power 54 across power delivery line 31 to a power supply, such as an Uninterruptible Power Supply (UPS) unit 34. UPS unit 34 provides power to a set of one or more powered devices 42 (depicted as powered devices 42(a), 42(b), 42(c), . . . ).

In some embodiments, environment 32 also includes a lookup server 35 that runs a pricing module 36 configured to periodically obtain pricing information 52 from the utility 32 over a network 35 and to send that pricing information to the UPS unit 34. In other embodiments, pricing module 36 instead runs on the UPS unit 34 itself, allowing the UPS unit 34 to directly obtain the pricing information 52 from the utility 32 over the network 35.

Lookup server 35 may be any kind of computing device, such as, for example, a personal computer, laptop, workstation, server, enterprise server, tablet, smartphone, embedded controller, etc. In an example embodiment lookup server 35 is a server.

Network 35 may be any kind of communications network or set of communications networks, such as, for example, a LAN, WAN, SAN, the Internet, a wireless communication network, a virtual network, a fabric of interconnected switches, etc.

UPS unit 34 includes power input circuitry 33, a battery 39, power provision circuitry 38, network interface circuitry 36, processing circuitry, and memory 40. UPS unit 34 may also include various additional features (not depicted), such as, for example, interconnection circuitry, buses, mounting boards, a housing, etc. In some embodiments (not depicted), the battery 39 may be located outside of the UPS unit 34. In some embodiments (not depicted), there may be several batteries 39 located inside and/or outside of the UPS unit 34.

Power input circuitry 33 is configured, under normal operating conditions, to obtain power 54 from the utility 32 and to provide that power to the power provision circuitry 38 and to other local components of the UPS unit 34. Power input circuitry 33 is also configured to provide power to charge the battery 39 under certain conditions.

Power provision circuitry 38 is configured to receive power either from the power input circuitry 33 or the battery 39 and to provide power to the devices 42, as needed.

Battery 39 may be any kind of storage for power. In an example embodiment, battery 39 is a Li-Ion battery.

Network interface circuitry 36 may include one or more Ethernet cards, cellular modems, Fibre Channel (FC) adapters, InfiniBand adapters, wireless networking adapters (e.g., Wi-Fi), and/or other devices for connecting to network 35.

Processing circuitry 37 may include any kind of processor or set of processors configured to perform operations, such as, for example, a microprocessor, a multi-core microprocessor, a digital signal processor, a system on a chip, a collection of electronic circuits, a similar kind of controller, or any combination of the above. Memory 40 may include any kind of digital system memory, such as, for example, random access memory (RAM), read-only memory (ROM), one-time programmable (OTP) memory, and/or flash memory.

Memory 40 stores a power source assignment module (PSAM) 44 in operation on processing circuitry 37, and various data 52, 53, 56, 57, 58, 59, 60, 62, 64, 66, 68, 70, 72, 74, 76, 78, 80, 82, 84, 86, and/or 88. In some embodiments, memory 40 also stores pricing module 36 in operation on processing circuitry 37.

In operation, pricing module 36 communicates with the utility 32 to receive and store the pricing information 52 within memory 40. Pricing information 52 includes a price 53 (depicted as prices 53(1), 53(2), . . . , 53(N), . . ., 53(2N)) per unit of power in each of a plurality of time slots over a lookahead period 56. Lookahead period 56 has a length 57. In an example embodiment, lookahead period has a length of 24 hours or longer, and each time slot has a length of 1 hour. The set of time slots of the lookahead period 56 may be divided into a first subset 58 and a second subset 59, each of which has N time slots (e.g., N=12). In some embodiments, subsets 58, 59 are non-overlapping, while, in other embodiments, the beginning of second subset 59 may overlap with the end of the first subset 58. In some embodiments, the length 57 is equal to exactly 2N time slots, while in other embodiments, length 57 may exceed 2N time slots. There may be time slots of the lookahead period 56 that are not in either subset 58, 59.

In operation, PSAM 44 determines a highest cost 60 of power 54 of the first subset 58 and which time slot 62 has that highest cost 60. PSAM 44 also determines the lowest cost 64 of power 54 over the first subset 58 as well as the cost difference 66 between the highest cost 60 and the lowest cost 64. For example, if the highest cost 60 is $0.50 per kilowatt-hour (kWh) and lowest cost 64 is $0.12 per kWh, then the cost difference 66 would be $0.38 per kWh.

PSAM 44 determines whether the battery 39 is “full” by comparing a present state of charge (SoC) 70 of the battery 39 to a fullness threshold 72 (e.g., a value within a range of 85% to 100%). In an example embodiment, the fullness threshold 72 is 90%; thus, if the present SoC 70 is at least 90%, then the battery 39 is deemed to be full. If the battery 39 is full, then PSAM 44 determines whether the cost difference 66 exceeds a threshold difference 68, and if so, it assigns a discharge time slot assignment 74. For example, if the threshold difference 68 is $0.25/kWh, and the cost difference 66 is $0.38/kWh as described above, then the discharge time slot assignment 74 would be set to the highest cost time slot 62. If, however, the threshold difference 68 is $0.45/kWh, then the discharge time slot assignment 74 would be unassigned.

In some embodiments, the assignment of a discharge time slot assignment 74 is further dependent on a lookback period 80 having a length 81 (e.g., a period of 10-50 days). In these embodiments, PSAM 44 keeps track of a number 82 of discharge/recharge cycles of the battery 39 over the lookback period 80 (e.g., over the last 30 days). A discharge/recharge cycle may be defined as the SoC of the battery 39 dropping below the fullness threshold 72 and subsequently being recharged above that threshold 72. A maximum allowed number 84 of discharge/recharge cycles over the lookback period 80 may be pre-defined, for example within a range of 5 to 10 times. In an example embodiment, the length 81 of the lookback period 80 is within a range of 10 to 50 (e.g., 30) days, and the maximum allowed number 84 is 8 times. If the maximum allowed number 84 of discharge/recharge cycles over the lookback period 80 exceeds the number 82 of discharge/recharge cycles of the battery 39 over the lookback period 80, then PSAM 44 goes on to consider the cost difference 66 versus the threshold difference 68; otherwise, PSAM 44 leaves the assignment of a discharge time slot assignment 74 as unassigned.

In some embodiments, the threshold difference 68 is a sliding threshold based on the number 82 of discharge/recharge cycles of the battery 39 over the lookback period 80. For example, in an embodiment, the threshold difference 68 is defined to be an acceptable value 86 times the number 82 of discharge/recharge cycles divided by the maximum allowed number 84. Thus, as the number 82 of discharge/recharge cycles over the lookback period 80 gets closer to the maximum allowed number 84 of discharge/recharge cycles over the lookback period 80, the higher the threshold difference 68 is.

Once the discharge time slot assignment 74 is assigned, PSAM 44 operates to cause the power provision circuitry 38 to draw power from the battery 39 to power attached devices 42 in lieu of (or in addition to) drawing power from the power input circuitry 33 during the time slot defined by the discharge time slot assignment 74. In some embodiments, the maximum rate at which the power provision circuitry 38 may draw power from the battery 39 is defined such that by drawing power at that maximum rate, the SoC 70 of the battery 39 does not drop below a minimum allowed battery SoC 88 (e.g., 50-80%). For example, if the minimum allowed battery SoC 88 is 65% and the SoC 70 of the battery 39 at the beginning of the time slot defined by the discharge time slot assignment 74 is 95% and the length of a time slot is 1 hour, then the maximum rate at which the power provision circuitry 38 may draw power from the battery 39 would be 30% in 60 minutes. Thus, if the battery 39 has a rated maximum storage capacity of 10 kWh, then the maximum rate at which the power provision circuitry 38 may draw power from the battery 39 would be 3 kW for 1 hour, which equals 3 kWh (or 30% of 10 kWh). If the power needs of the attached devices 42 exceeds the maximum rate at which the power provision circuitry 38 may draw power from the battery 39, then additional power 54 may be drawn by the power input circuitry 33 from the utility 32 to supplement power from the battery 39.

Once the time slot defined by the discharge time slot assignment 74 is over, PSAM 44 may operate to recharge the battery 39. Thus, if the SoC 70 of the battery 39 is below the fullness threshold 72 after the time slot defined by the discharge time slot assignment 74, then PSAM 44 may operate to recharge the battery 39 during a recharge time slot assignment 78 within a second subset 59 of the time slots of the lookahead period 56.

In some embodiments, the second subset 59 is defined to begin just after the time slot defined by the discharge time slot assignment 74, while in other embodiments, the second subset 59 is defined to begin just after the end of the first subset 58. PSAM 44 determines the lowest cost 76 of power during the second subset 59 and assigns the recharge time slot assignment 78 to be the time slot during which that lowest cost 76 occurs. Once the recharge time slot assignment 78 is assigned, PSAM 44 operates to cause the power input circuitry 33 to draw extra power 54 from the utility 32 during the time slot defined by the recharge time slot assignment 78 in order to recharge the battery 39. In some embodiments, PSAM 44 performs the assignment of the recharge time slot assignment 78 just after assigning the discharge time slot assignment 74, while in other embodiments, PSAM 44 performs the assignment of the recharge time slot assignment 78 just after the completion of the discharge time slot assignment 74.

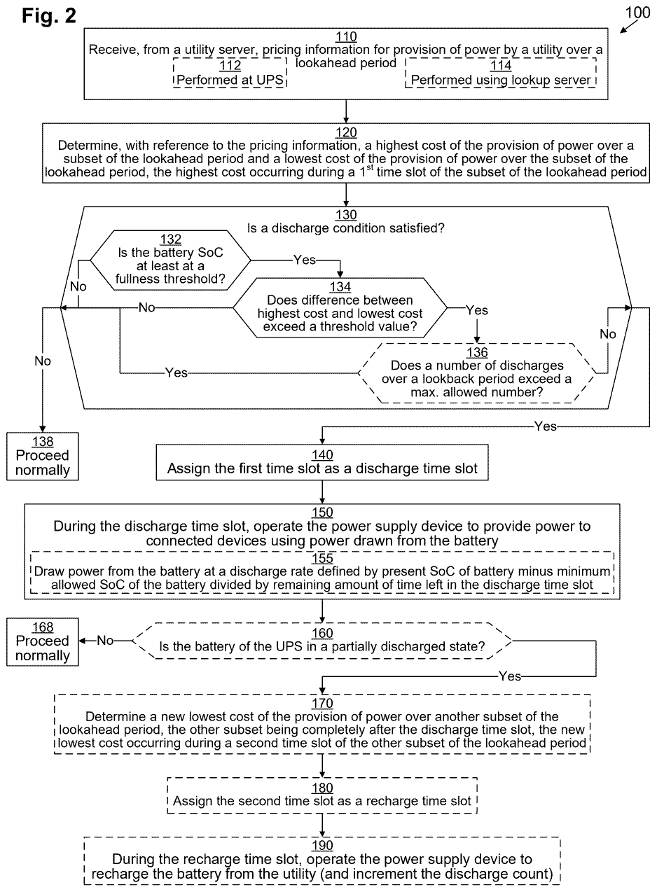

FIG. 2 illustrates an example method 100 performed by PSAM 44 and pricing module 36 for managing supplemental provision of power from the battery 39 even when the UPS unit 34 is online and capable of receiving power from the utility 32. It should be understood that any time a piece of software (e.g., PSAM 44, pricing module 36, etc.) is described as performing a method, process, step, or function, what is meant is that a computing device (e.g., UPS unit 34, lookup server 35, etc.) on which that piece of software is running performs the method, process, step, or function when executing that piece of software on its processing circuitry 37. It should be understood, that one or more of the steps or sub-steps of method 100 may be omitted in some embodiments. Similarly, in some embodiments, one or more steps or sub-steps may be combined or performed in a different order. Dashed lines indicate that a step or sub-step is either optional or representative of alternate embodiments or use cases.

In step 110, pricing module 36 receives pricing information 52 for the provision of power 54 by a utility 32 over a lookahead period 56. In some embodiments (sub-step 112), step 110 is performed by the pricing module 36 running on the UPS unit 34 itself. In other embodiments (sub-step 114), step 110 is performed by the pricing module 36 running on a remote lookup server 35 obtaining the pricing information 52 from the utility 32 and then sending the obtained pricing information 52 on to the UPS unit 34. In either case, the pricing information 52 is stored on UPS 34.

In step 120, PSAM 44 determines, with reference to the pricing information 52, the highest cost 60 of the provision of power 54 over a subset 58 of the lookahead period 56 and a lowest cost 64 of the provision of power 54 over the subset 58 of the lookahead period 56, the highest cost 60 occurring during a first time slot of the subset 58 of the lookahead period 56.

In step 130, PSAM 44 determines whether a discharge condition is satisfied. Determining whether the discharge condition is satisfied includes sub-steps 132, 134. In some embodiments, determining whether the discharge condition is satisfied further includes sub-step 136. If the discharge condition is satisfied, then operation proceeds with step 140; otherwise operation proceeds with step 138.

In sub-step 132, PSAM 44 determines whether the battery (or batteries) 39 of a power supply device (e.g., UPS unit 34) has an SoC 70 of at least the fullness threshold 72. If not, the discharge condition is not satisfied. If sub-step 132 returns an affirmative response, then, in sub-step 134, PSAM 44 determines whether the difference between the highest cost 60 and the lowest cost 64 exceeds a threshold value 68. If not, the discharge condition is not satisfied. If sub-step 134 returns an affirmative response, then, in some embodiments, the discharge condition is deemed to be satisfied; in other embodiments, operation proceeds with sub-step 136.

In some embodiments, threshold value 68 is a sliding scale value, and sub-step 134 also includes an operation (not depicted) of determining the value of threshold value 68. In an example embodiment, this determination may include multiplying the acceptable value 86 by the number 82 of discharge/recharge cycles over the lookback period 80 divided by the maximum allowed number 84 of discharge/recharge cycles over the lookback period 80 to yield the threshold value 68. For example, if the acceptable value 86 is $0.50, the length lookback period 80 is 30 days, and the maximum allowed number 84 of discharge/recharge cycles over the lookback period 80 is 8 times, then the threshold value 68 varies between zero (when the number 82 of discharge/recharge cycles over the lookback period 80 is zero) and $0.50×7/8=$0.4375 (when the number 82 of discharge/recharge cycles over the lookback period 80 is seven, which is one less than the maximum allowed number 84).

In sub-step 136, PSAM 44 determines whether the number 82 of discharge/recharge cycles over the lookback period 80 has already reached the maximum allowed number 84 of discharge/recharge cycles over the lookback period 80. If so, the discharge condition is not satisfied. If sub-step 136 returns a negative response, then the discharge condition is deemed to be satisfied. In some embodiments, the order of sub-steps 134, 136 may be switched, so that sub-step 134 is only performed if sub-step 136 has a negative result (i.e., if the number 82 of discharge/recharge cycles over the lookback period 80 is less than the maximum allowed number 84 of discharge/recharge cycles over the lookback period 80).

When the discharge condition is satisfied, in step 140, PSAM 44 assigns the highest cost time slot 62 to the discharge time slot assignment 74.

When the discharge condition is not satisfied, in step 138, operation proceeds normally without assigning any discharge time slot assignment 74. Thus, method 100 terminates until it is performed beginning with step 110 at a later time (e.g., the next day).

In step 150, during the time slot defined by the discharge time slot assignment 74, PSAM 44 operate the power supply device 34 to provide power to connected devices 42 using power drawn from the battery 39. In some embodiments, step 150 includes sub-step 155. In sub-step 155, power provision circuitry 38 draws power from the battery 39 at a discharge rate defined by the present SoC 70 of the battery 39 minus the minimum allowed battery SoC 88 divided by the remaining amount of time within the time slot defined by the discharge time slot assignment 74. If this amount is insufficient to power the connected devices 42, then power provision circuitry 38 draws additional power 54 from the utility 32 via the power input circuitry 33.

In some embodiments, in step 160, PSAM 44 determines whether the battery 39 of the UPS unit 34 is in a partially discharged state (e.g., whether the present SoC 70 is below the fullness threshold 72). If so, operation proceeds with step 170; otherwise operation proceeds with step 168. In step 168, operation proceeds normally without assigning any recharge time slot assignment 78. Thus, method 100 terminates until it is performed beginning with step 110 at a later time (e.g., the next day).

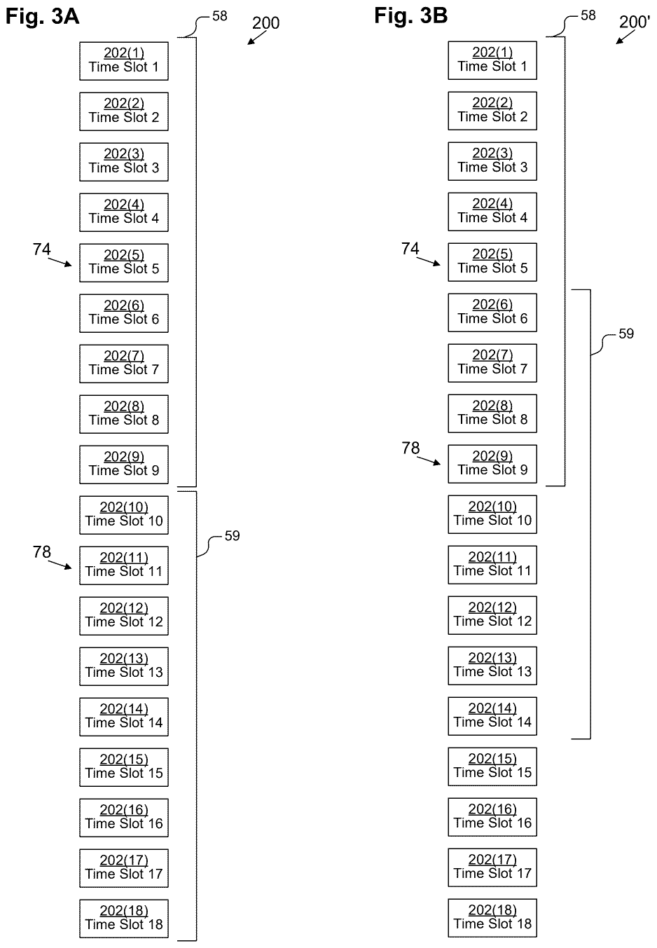

In step 170, PSAM 44 determines, with reference to the pricing information 52, the lowest cost 76 of the provision of power 54 over another subset 59 of the lookahead period 56, the other subset 59 being completely after the time slot defined by the discharge time slot assignment 74, the lowest cost 76 occurring during a time slot of the other subset 59 of the lookahead period 56. Then, in step 180, PSAM 44 assigns the recharge time slot assignment 78, defining the time slot of the other subset 59 having the lowest cost 76 as the recharge time slot. This may be illustrated with reference to FIGS. 3A and 3B

FIG. 3A illustrates an example scenario 200 in which each subset 58, 59 contains nine time slots 202. Although twelve time slots 202 is more typical, only nine are depicted for the sake of clarity. Thus, first subset 58 contains time slots 202(1), 202(2), . . . , 202(9). In this scenario 200, time slot 202(5) is defined by the discharge time slot assignment 74 as the discharge time slot. In the embodiment of scenario 200, second subset 59 must begin after first subset 58 is completed, so second subset 59 contains time slots 202(10), 202(11), . . . , 202(18). The time slot 202 within the second subset 59 whose price assignment 53 has the lowest cost 76 is time slot 202(11), so the recharge time slot assignment 78 defines time slot 202(11) as the recharge time slot.

FIG. 3B illustrates another example scenario 200′according to another embodiment in which second subset 59 must begin after the time slot defined by the discharge time slot assignment 74 is completed, but not necessarily after the first subset 58 is completed. Thus, first subset 58 contains time slots 202(1), 202(2), . . . , 202(9, and time slot 202(5) is defined by the discharge time slot assignment 74 as the discharge time slot, as in scenario 200. However, in scenario 200′, second subset 59 begins right after discharge time slot 202(5), so second subset 58 contains time slots 202(6), 202(7), . . . , 202(14). Thus, subsets 58, 59 overlap in that they both contain time slots 202(6), 202(7), 202(9), and 202(9). In this scenario 200′, time slot 202(9) has a lower price assignment 53 than does time slot 202(11), so the recharge time slot assignment 78 defines time slot 202(9) as the recharge time slot.

Returning to FIG. 2, in step 190, during the recharge time slot defined by the recharge time slot assignment 78 (e.g., time slot 202(11) in scenario 200 or time slot 202(9) in scenario 200′), PSAM 44 operate the power supply device 34 to recharge the battery 39 from the utility 32 using the power input circuitry 33. PSAM 44 may also increment the number 82 of discharge/recharge cycles of the battery 39 over the lookback period 80 at this point. Of course, as the start point of the lookback period 80 advances, any discharge/recharge cycles of the battery 39 that were previously at the beginning of the lookback period 80 (but no longer are after the start point advances) must be subtracted from the number 82.

While various embodiments of the invention have been particularly shown and described, it will be understood by those skilled in the art that various changes in form and details may be made therein without departing from the spirit and scope of the invention as defined by the appended claims.

It should be understood that although various embodiments have been described as being methods, software embodying these methods is also included. Thus, one embodiment includes a tangible computer-readable medium (such as, for example, a hard disk, a floppy disk, an optical disk, computer memory, flash memory, etc.) programmed with instructions, which, when performed by a computer or a set of computers, cause one or more of the methods described in various embodiments to be performed. Another embodiment includes a computer which is programmed to perform one or more of the methods described in various embodiments.

Furthermore, it should be understood that all embodiments which have been described may be combined in all possible combinations with each other, except to the extent that such combinations have been explicitly excluded.

Finally, nothing in this Specification shall be construed as an admission of any sort. Even if a technique, method, apparatus, or other concept is specifically labeled as “background” or as “conventional,” Applicants make no admission that such technique, method, apparatus, or other concept is actually prior art under 35 U.S.C. § 102 or 103, such determination being a legal determination that depends upon many factors, not all of which are known to Applicants at this time.

What is claimed is:

1. A computer program product comprising a non-transitory computer-readable storage medium storing instructions, which, when performed by processing circuitry, cause a system to:
receive, from a utility server, pricing information for provision of power by a utility over a lookahead period;
determine, with reference to the pricing information, a highest cost of the provision of power over a subset of the lookahead period and a lowest cost of the provision of power over the subset of the lookahead period, the highest cost occurring during a first time slot of the subset of the lookahead period;
in response to determining that a discharge condition is satisfied, assign the first time slot as a discharge time slot, wherein determining that the discharge condition is satisfied includes:
(1) determining that a battery of a power supply device has a state of charge (SoC) of at least a fullness threshold and
(2) determining that a difference between the highest cost and the lowest cost exceeds a threshold value; and
during the discharge time slot, operate the power supply device to provide power to connected devices using power drawn from the battery.

2. The computer program product of claim 1 wherein the instructions, which, when performed by the processing circuitry, further cause the system to, in response to determining that the battery of the power supply device is in a partially discharged state after the discharge time slot:
determine a new lowest cost of the provision of power over another subset of the lookahead period, the other subset being completely after the discharge time slot, the new lowest cost occurring during a second time slot of the other subset of the lookahead period;
assign the second time slot as a recharge time slot; and
during the recharge time slot, operate the power supply device to recharge the battery from the utility.

3. The computer program product of claim 2 wherein the subset and the other subset are non-overlapping, the other subset beginning immediately after the subset.

4. The computer program product of claim 2 wherein:
the lookahead period is at least 24 hours;
the subset includes 12 non-overlapping time slots that are each 1 hour long, including the first time slot; and
the other subset includes 12 non-overlapping time slots that are each 1 hour long, including the second time slot.

5. The computer program product of claim 1 wherein determining that the discharge condition is satisfied further includes determining that a number of discharges over a lookback period does not exceed a maximum allowed number of discharges.

6. The computer program product of claim 5 wherein the threshold value is a sliding threshold based on the number of discharges over the lookback period.

7. The computer program product of claim 6 wherein the sliding threshold is defined by multiplying an acceptable price difference by the number of discharges over the lookback period divided by the maximum allowed number of discharges.

8. The computer program product of claim 5 wherein the lookback period is within a range of 10 to 50 days.

9. The computer program product of claim 5 wherein the maximum allowed number of discharges is within a range of 5 to 10.

10. The computer program product of claim 1 wherein providing power to connected devices using power drawn from the battery includes drawing power from the battery at a discharge rate defined by a present SoC of the battery minus a minimum allowed SoC of the battery divided by a remaining amount of time left in the discharge time slot.

11. The computer program product of claim 10 wherein the minimum allowed SoC of the battery is within a range of 50% to 80%.

12. The computer program product of claim 1 wherein the fullness threshold is a value within a range of 85% to 100%.

13. The computer program product of claim 1 wherein:
receiving the pricing information for provision of power from the utility server includes a lookup server device obtaining the pricing information from the utility server and the lookup server device sending the obtained pricing information to the power supply device; and
determining the highest cost and lowest cost and assigning the first time slot as the discharge time slot are performed by the power supply device.

14. The computer program product of claim 1 wherein the processing circuitry is within the power supply device.

15. A system comprising:
a power supply device; and
processing circuitry coupled to memory configured to:
receive, from a utility server, pricing information for provision of power by a utility over a lookahead period;
determine, with reference to the pricing information, a highest cost of the provision of power over a subset of the lookahead period and a lowest cost of the provision of power over the subset of the lookahead period, the highest cost occurring during a first time slot of the subset of the lookahead period;
in response to determining that a discharge condition is satisfied, assign the first time slot as a discharge time slot, wherein determining that the discharge condition is satisfied includes:
(1) determining that a battery of a power supply device has a state of charge (SoC) of at least a fullness threshold and
(2) determining that a difference between the highest cost and the lowest cost exceeds a threshold value; and
during the discharge time slot, operate the power supply device to provide power to connected devices using power drawn from the battery.

16. The system of claim 15 wherein the processing circuitry coupled to memory is within the power supply device.

17. The system of claim 15 wherein:
the system further comprises a lookup server device configured to:
obtain the pricing information from the utility server and
send the obtained pricing information to the power supply device; and
the processing circuitry configured to determine the highest cost and lowest cost and the processing circuitry configured to assign the first time slot as the discharge time slot are within the power supply device.

18. A method performed by processing circuitry, the method comprising:
receiving, from a utility server, pricing information for provision of power by a utility over a lookahead period;
determining, with reference to the pricing information, a highest cost of the provision of power over a subset of the lookahead period and a lowest cost of the provision of power over the subset of the lookahead period, the highest cost occurring during a first time slot of the subset of the lookahead period;
in response to determining that a discharge condition is satisfied, assigning the first time slot as a discharge time slot, wherein determining that the discharge condition is satisfied includes:
(1) determining that a battery of a power supply device has a state of charge (SoC) of at least a fullness threshold and
(2) determining that a difference between the highest cost and the lowest cost exceeds a threshold value; and
during the discharge time slot, operating the power supply device to provide power to connected devices using power drawn from the battery.

19. The method of claim 18 wherein the method further comprises, in response to determining that the battery of the power supply device is in a partially discharged state after the discharge time slot:
determining a new lowest cost of the provision of power over another subset of the lookahead period, the other subset being completely after the discharge time slot, the new lowest cost occurring during a second time slot of the other subset of the lookahead period;
assigning the second time slot as a recharge time slot; and
during the recharge time slot, operating the power supply device to recharge the battery from the utility.

20. The method of claim 18 wherein the subset and the other subset are non-overlapping, the other subset beginning immediately after the subset.

21. The method of claim 19 wherein:
the lookahead period is at least 24 hours;
the subset includes 12 non-overlapping time slots that are each 1 hour long, including the first time slot; and
the other subset includes 12 non-overlapping time slots that are each 1 hour long, including the second time slot.

22. The method of claim 18 wherein determining that the discharge condition is satisfied further includes determining that a number of discharges over a lookback period does not exceed a maximum allowed number of discharges.

23. The method of claim 22 wherein the threshold value is a sliding threshold based on the number of discharges over the lookback period.

24. The method of claim 23 wherein the sliding threshold is defined by multiplying an acceptable price difference by the number of discharges over the lookback period divided by the maximum allowed number of discharges.

25. The method of claim 18 wherein providing power to connected devices using power drawn from the battery includes drawing power from the battery at a discharge rate defined by a present SoC of the battery minus a minimum allowed SoC of the battery divided by a remaining amount of time left in the discharge time slot.
